(19) United States
(12) Patent Application Publication
(10) Pub. No.: US 2026/0187167 A1
(43) Pub. Date: Jul. 2, 2026

(54) TRAINING A LANGUAGE MODEL FOR DOMAIN-SPECIFIC QUERIES

(71) Applicant: Maplebear Inc., San Francisco, CA (US)

(72) Inventors: Prithvishankar Srinivasan, Seattle, WA (US); Shishir Kumar Prasad, San Ramon, CA (US); Venkata Satya Pradeep Karuturi, Los Angeles, CA (US)

(21) Appl. No.: 19/006,884

(22) Filed: Dec. 31, 2024

(51) Int. Cl. G06F 16/9535; G06F 16/242; G06F 16/9538; G06N 3/0475; G06N 3/09

(52) U.S. Cl. CPC G06F 16/9535; G06F 16/243; G06F 16/9538; G06N 3/0475; G06N 3/09

(57) ABSTRACT

A large language model (LLM) is trained to provide domain specific answers. First, item information is extracted from a catalog of items. A machine-learning model is then prompted to generate a set of queries based in part on the item information associated with the items. Training examples are generated that are associated with the items using a first subset of queries from the set. Each training example is for a corresponding item, and includes a query (that is associated with the corresponding item and is from the first subset) and some item information that is an answer to the query and that is associated with the corresponding item. The LLM is trained using the training examples. Performance of the LLM is evaluated using a second subset of the set of queries that is separate from the first subset.

### BACKGROUND

A large language model is conventionally trained with a large set of data, for example, one with tens of trillions of tokens. This training process injects the large language model with general knowledge and concepts that the large language model can use to respond to questions. However, a conventionally trained large language model may lack specific domain knowledge, such as domain knowledge of one or more online shopping platforms. Regardless, an online shopping platform may use a conventionally trained large language model in responding to user queries. However, as the conventionally trained large language model lacks specific domain information (e.g., catalog information) of the online shopping platform, it returns generic responses and not responses that include specific domain information (e.g., a specific product in the catalog information) for the online shopping platform. The online shopping platform would then have to spend time and resources to map the generic responses to specific products in their catalog, before being able to respond to users with any specific products that may satisfy the queries. Accordingly, it can be inefficient for online shopping platforms to use conventionally trained large language models in responding to user requests for product recommendations as these large language models lack domain specific knowledge of the online shopping platforms.

### SUMMARY

In accordance with one or more aspects of the disclosure, training a large language model for domain specific answers is described. An online system may extract item information from a catalog of items. The item information includes, for a given item, an item name, an item identifier, and an item description. The online system extracts item information for some or all of the items of the catalog. The online system prompts a machine-learning model to generate a set of queries based in part on the extracted item information associated with the items. The prompting is such that the generated set of queries includes, for each item, a corresponding plurality of queries whose answers are based on item information for that item. The online system generates training examples that are associated with the items (for which item information was extracted) using a first subset of queries from the set of queries. Each training example is for a corresponding item, includes a query that is associated with the corresponding item and is from the first subset, and includes some item information that is an answer to the query and that is associated with the corresponding item. The online system trains a large language model (e.g., an enhanced large language model) using the training examples. The online system evaluates performance of the large language model using a second subset of the set of queries that is separate from the first subset.

The large-language manner is trained to respond to queries requesting a recommendation for an item with specific item information of items that satisfy the queries. As such, the trained large language model is able to respond to queries with domain specific answers (i.e., item information for items that satisfy the queries). The online system may then respond to the queries with item recommendations that are or are based on the item information. In this manner, the online system is able to leverage the large language model to quickly respond to queries from user devices. In contrast, conventionally trained-large models that have been prompted with queries might not be able to provide domain specific answers, and instead output generic answers to the queries. This results in conventional shopping platforms having to perform additional processes in order to identify specific items that match the generic answers, before they are able to provide an effective response to the queries.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIGS. 3A-3B form an example sequence diagram that describes training an enhanced large language model, in accordance with some embodiments.

FIG. 4 is an example sequence diagram that describes using an enhanced large language model to respond to queries with domain specific answers, in accordance with some embodiments.

FIG. 5 is a flowchart for a method of training a large language model for domain specific answers, in accordance with some embodiments.

### DETAILED DESCRIPTION

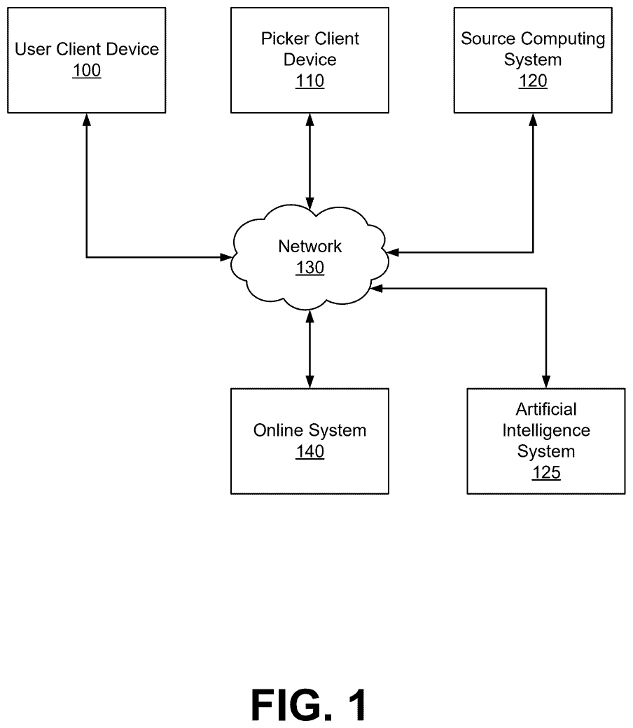

FIG. 1 illustrates an example system environment for an online system 140, in accordance with one or more embodiments. The system environment illustrated in FIG. 1 includes a user client device 100, a picker client device 110, a source computing system 120, an artificial intelligence (AI) system 125, a network 130, and an online system 140. Alternative embodiments may include more, fewer, or different components from those illustrated in FIG. 1, and the functionality of each component may be divided between the components differently from the description below. For example, some or all of the functionality of the AI system 125 may be performed by the online system 140. Additionally, each component may perform their respective functionalities in response to a request from a human, or automatically without human intervention.

Although one user client device 100, picker client device 110, AI system 125, and source computing system 120 are illustrated in FIG. 1, any number of users, pickers, AI systems, and sources may interact with the online system 140. As such, there may be more than one user client device 100, picker client device 110, AI system 125, or source computing system 120.

The user client device 100 is a client device through which a user may interact with the picker client device 110, the source computing system 120, or the online system 140. The user client device 100 may be referred to as a “user device.” The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The user client device 100 may receive a query for a recommendation for an item from the user. The query may be, e.g., “What is a good gift for Valentine's Day?” The user client device 100 may receive the query from the user via, e.g., the ordering interface. The user client device 100 provides the query to the online system 140. The user client device 100 receives a response to the query from the online system 140. The response includes one or more recommendations for items that are associated with one or more items that satisfy the query. Each recommendation for an item includes item information (e.g., item name, item identifier, etc.) associated with the item. The user client device 100 presents (e.g., via the ordering interface) the one or more recommendations of items to the user.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The AI system 125 may be configured to apply prompts to one or more machine-learning models to generate responses to the prompts. The AI system 125 includes one or more machine-learning models. The one or more machine-learning models may be generative machine-learning models.

The AI system 125 may generate queries based in part on item information. The AI system 125 may receive a prompt from the online system 140 to generate a set of queries based in part on item information (e.g., item descriptions and/or item names) associated with items. The AI system 125 provides the generated set of queries to the online system 140.

In some embodiments, the AI system 125 may help evaluate performance of an enhanced large language model (LLM). The AI system 125 may receive a prompt from the online system 140 to identify queries, from a plurality of queries that were applied to the enhanced LLM, whose answers do not include correct item information. The prompt also includes a set of correct answers for each of the plurality of queries. The AI system 125 may apply the prompt to the machine-learning model. The output of the machine-learning model identifies queries from the plurality of queries whose answers from the enhanced LLM included incorrect item information. In some embodiments, the machine-learning model is a same machine-learning model that is used to generate queries, in other embodiments they are different machine-learning models. The AI system 125 may provide the output of the machine-learning model to the online system 140.

The user client device 100, the picker client device 110, the source computing system 120, the AI system 125, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 trains an enhanced large language model (LLM) to handle domain specific queries. Specifically, an enhanced LLM is trained to respond to queries for recommendations for items with item information associated with items that satisfy the queries and are from a catalog of items. The online system 140 may extract item information associated with items from the catalog of items. For a given item, the extracted item information may include an item name, an item identifier, and an item description. The online system 140 may prompt a machine-learning model (e.g., of the AI system 125 and/or of the online system 140) to generate a set of queries based in part on the item information associated with the items. The set of queries may include, for each item, a corresponding plurality of queries whose answers are based on item information for that item. The online system 140 receives the set of queries from the machine-learning model.

The online system 140 may generate a set of query-answer pairs using the received queries and corresponding answers (i.e., item information). A query-answer pair is associated with an item and includes a query and an answer to the query, wherein the answer is at least some of the item information (e.g., item name and item identifier) for the item.

The online system 140 may generate training examples that are associated with the items using a first subset of the set of query-answer pairs. For example, the online system 140 may generate training examples that are associated with the items using queries and corresponding answers from the first subset. Each training example is associated with a corresponding item, and includes a query that is associated with the corresponding item and is from the first subset, and includes some item information that is an answer to the query and that is associated with the corresponding item. The online system 140 trains the enhanced LLM using the training examples.

The set of query-answer pairs can be organized into a plurality of groups that are associated with different items. Each group includes a plurality of query-answer pairs that are associated with a same item, and include a plurality of queries that have a same answer that is based on item information (e.g., item name, item identifier, etc.) for that item. The set of query-answer pairs may be subdivided into a first subset, a second subset (e.g., that is different from the first subset), and in some cases a third subset (e.g., that is different from the first subset and/or the second subset). The first subset is used for training the enhanced LLM, the second subset is used for evaluating performance of the enhanced LLM, and the third subset may be used for additional training of the enhanced LLM. And each of the plurality of groups may include part of the first subset, the second subset, and in some cases the third subset. For example, a group associated with a particular item (of the catalog) may include two query-answer pairs in the first subset, and one or more query-answer pairs in the second subset that are different than the query-answer pairs in the first subset and are associated with the particular item. The first subset, the second subset, and the third subset may span the plurality of groups such that, in each of the plurality of groups there are corresponding portions of the first subset, the second subset, and the third subset.

The online system 140 may evaluate performance of the enhanced LLM using the second subset of query-answer pairs. For example, the online system 140 may apply queries from the second subset for some or all of the items to the enhanced LLM which outputs corresponding answers. The online system 140 may compare the answers to the expected item information (determined from the answers of the second subset of query-answer pairs) to determine performance of the enhanced LLM. In some embodiments, the online system 140 may prompt a machine learning model (e.g., of the AI system 125) to identify queries of the second subset whose answers from the enhanced LLM do not include correct item information. The online system 140 may also include with the prompt a set of correct answers for each of the queries of the second subset that were applied to the enhanced LLM. In some embodiments, where the enhanced LLM performs below a target level (e.g., the enhanced LLM provides correct item information for a query), the online system 140 may re-train the enhanced LLM to increase performance in responding to those queries.

The online system 140 is an online system by which users can order items to be provided to them by a picker from a source. The online system 140 may receive a query (e.g., “What is a good Valentine's Day gift?”) for a recommendation for an item from a user client device 100. The online system 140 generates a prompt based in part on the query, and prompts the enhanced LLM. As the enhanced LLM is trained to provide domain specific answers (i.e., return item information for items that satisfy the query), the output of the enhanced LLM may include item information for one or more items that are part of the catalog and may satisfy the query. For example, the output may include item names (e.g., Island Gourmet Chocolates) and item identifiers (e.g., #22598766A) for the one or more items. In some embodiments, the output may also include item descriptions (e.g., Box of organic dark chocolates of various types, 24 ct.) for the one or more items. The online system 140 may generate item recommendations for the one or more items using the item information of the one or more items. In some embodiments, the online system 140 may select an item from the one or more items based in part on user data, order data, etc., and generate an item recommendation for the selected item. The online system 140 may provide, responsive to the query, the generated one or more item recommendations to the user client device 100.

The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

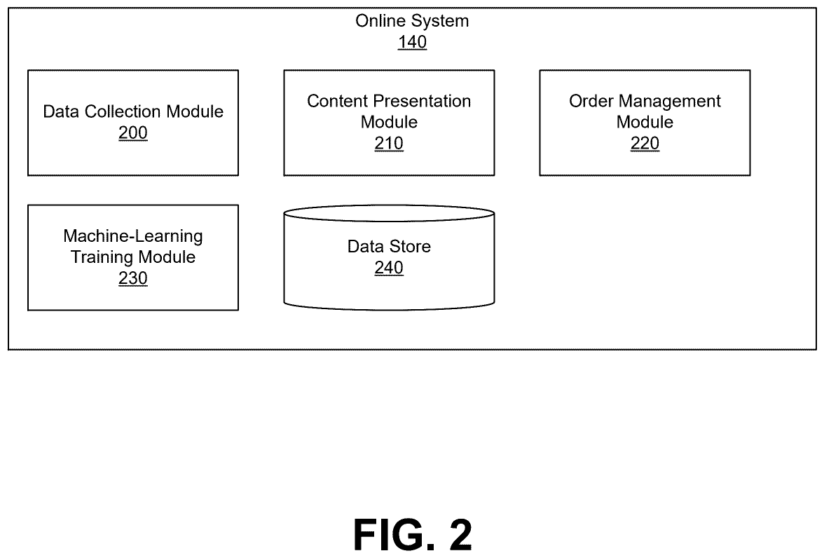

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. Item data for an item may include, e.g., an item name for the item, an item identifier for the item, and an item description for the item. The item data may include item identifiers for items that are available and may include quantities of items associated with each item identifier. Item identifiers may identify items in a catalog. The catalog may be a catalog of the online system 140. In some embodiments, the catalog may be a catalog of a source. The item description for an item may describe features of an item, and may also describe benefits of the item. In some embodiments, item descriptions may also include attributes of items such as the size, color, weight, stock keeping unit (SKU), or serial number for the item. In some embodiments, the item information may also include one or more images of the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order.

The content presentation module 210 receives queries for item recommendations from user client devices. The content presentation module 210 may generate prompts based on received queries, and prompt an enhanced LLM with the queries. In some embodiments, the enhanced LLM is part of the online system 140. In other embodiments, the enhanced LLM may be part of a third party system (e.g., the AI system 125). The enhanced LLM is trained to have domain specific knowledge of the catalog. Responsive to the prompting, the enhanced LLM outputs item information (e.g., item names and item identifiers) associated with items that may satisfy the queries. The content presentation module 210 generates item recommendations for the items using the item information. An item recommendation for an item includes item information for that item. The content presentation module 210 may also retrieve pricing information for an item, and include the pricing information as part of the item recommendation.

The content presentation module 210 may provide (e.g., for presentation via the ordering interfaces) item recommendations for one or more the items that may satisfy the queries to the user client devices.

The content presentation module 210 also may identify items that the user is most likely to order and present item recommendations for those items to the user. For example, the content presentation module 210 may score items and rank the items based on their scores. The content presentation module 210 displays item recommendations for the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out item recommendations for items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine-learning training module 230 may train the enhanced LLM, and in some embodiments, may also train one or more machine-learning models of the AI system 125. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 extracts item information associated with items from the catalog. In some embodiments, the machine-learning training module 230 extracts item information for every item of the catalog. In some embodiments, the machine-learning training module 230 extracts item information for a portion of the items of the catalog. The item information extracted includes item names, item identifiers, and item descriptions.

The machine-learning training module 230 determines one or more prompts for a machine-learning model (e.g., of the AI system 125) to generate a set of queries based in part on the extracted item information. The one or more prompts instruct the machine-learning model to generate the set of queries in a manner such that, for each item, there is a corresponding plurality of queries whose answers are based on the item information for that item. In some embodiments, the prompt may instruct the machine-learning model to generate at least three different questions for each item based in part on the item information of that item.

The machine-learning training module 230 prompts the machine-learning model with the one or more prompts to generate a set of queries based in part on the item information associated with the items. The machine-learning model outputs the set of queries.

In some embodiments, the machine-learning training module 230 generates a set of query-answer pairs using the set of queries and their corresponding answers (i.e., item information). A query-answer pair is associated with an item and includes a query and an answer to the query, wherein the answer is at least some of the item information (e.g., item name and item identifier) for the item. The set of query-answer pairs can be organized into a plurality of groups that are associated with different items. Each group includes a plurality of query-answer pairs that are associated with a same item, and include a plurality of queries that have a same answer that is based on item information (e.g., item name, item identifier, etc.) for that item. For example, one of the items may have been a bouquet of roses, 12 ct, from Island Market that is associated with a group. And the group may include a plurality of queries (e.g., “What is a good gift for an anniversary?,” “What is a good gift for Valentine's Day?,” etc.) that are all have a same answer that is the item information associated with bouquet of roses, 12 ct, from Island Market. Answers to each of the queries in the group are item information associated with the bouquet of roses, 12 ct, from Island Market.

The set of query-answer pairs may be subdivided into a first subset, a second subset (e.g., that is different from the first subset), and in some cases a third subset (e.g., that is different from the first subset and/or the second subset). The subdivisions may span the plurality of groups such that each group includes a respective portion of the first subset, the second subset, and in some instances the third subset.

The item descriptions are particularly useful in the prompt, as the machine-learning model can use them to understand what the item is and what purpose the item is used for. And framing the queries around item descriptions (and in some cases item names) and item identifiers, can help in later training the enhanced LLM to associate certain concepts (e.g., Valentine's Day) with particular item identifiers (e.g., item identifiers for items that are chocolate, items that are flowers, etc.).

The machine-learning training module 230 generates a set of training examples using a first subset of the set of query-answer pairs. Each training example is associated with a corresponding item, and includes a query that is associated with the corresponding item and is from the first subset, and includes some item information that is an answer to the query and that is associated with the corresponding item. In some instances different training examples may include a same query but different answers. For example, a query “What is a good gift for Valentine's Day” may be in training examples for items relating to chocolate, flowers, jewelry, etc. In some embodiments, some or all of the set of training examples may include prefixes and target outputs. For example, a given training example may include a prefix that is the query of the training example and a target output that includes at least an item name and an item identifier which acts as an answer to the query.

The machine-learning training module 230 trains an enhanced LLM based on a set of training examples. Each training example includes input data (e.g., queries) to which the machine-learning model is applied to generate an output (e.g., item data). In some cases, the training examples also include a label which represents an expected output of the enhanced LLM. In these cases, the enhanced LLM is trained by comparing its output from the input data of a training example to the label for the training example. In general, during training with labeled data, the set of parameters of the enhanced LLM may be set or adjusted to reduce a difference between the output for the training example (given the current parameters of the model) and the label for the training example.

The machine-learning training module 230 may apply an iterative process to train the enhanced LLM whereby the machine-learning training module 230 updates parameter values of the enhanced LLM based on each of the set of training examples. The training examples may be processed together, individually, or in batches. To train the enhanced LLM based on a training example, the machine-learning training module 230 may apply the enhanced LLM to the input data in the training example to generate an output based on a current set of parameter values. The machine-learning training module 230 scores the output from the enhanced LLM using a loss function. A loss function is a function that generates a score for the output of the enhanced LLM such that the score is higher when the enhanced LLM performs poorly and lower when the enhanced LLM performs well. In cases where the training example includes a label, the loss function may also be based on the label for the training example. Some example loss functions include the mean square error function, the mean absolute error, hinge loss function, and the cross entropy loss function. The machine-learning training module 230 updates the set of parameters for the enhanced LLM based on the score generated by the loss function. For example, the machine-learning training module 230 may apply gradient descent to update the set of parameters.

In some embodiments, training describes fine tuning an LLM. For example, the machine-learning training module 230 may fine tune the enhanced LLM using the set of training examples. The machine-learning training module 230 may prompt the enhanced LLM using queries from the training examples. For example, a prompt may be “Answer the following question about an item of the online system. Make sure to include an item name, an item identifier, and an item description in the answer.” The machine-learning training module 230 may use the output (answers) and correct answers (from the query-answer pair) to the query in the fine tuning of the enhanced LLM. The machine-learning training module 230 may fine tune the enhanced LLM multiple times (e.g., 25 or more times) for each item. This can help the enhanced LLM learn, e.g., mappings between queries and item information.

In some embodiments, the machine-learning training module 230 fine tunes the LLM using parameter efficient fine tuning (PEFT) and the set of training examples to form the enhanced LLM. In some embodiments, the machine-learning training module 230 fine tunes the LLM using prefix fine tuning and the set of training examples to form the enhanced LLM. PEFT and prefix tuning use a small number of trainable parameters, and by doing so, drastically reduce computational costs and mitigates the risk of overfitting (relative to conventional training techniques).

The machine-learning training module 230 evaluates performance of the enhanced LLM using a second subset of the set of query-answer pairs. The second subset is separate from the first subset. In this manner, the machine-learning training module 230 is able to test performance of the enhanced LLM using queries from the second subset that the LLM was not specifically trained on. For example, the machine-learning training module 230 may select a query from a query-answer pair of the second subset. The query and correct answer are found in the query-answer pair, and the query-answer pair is associated with an item. The machine-learning training module 230 may apply the query to the enhanced LLM to generate an answer. The machine-learning training module 230 determines how close the answer is to the answer (item information associated with the item) of the query-answer pair. The machine-learning training module 230 may, e.g., determine that the enhanced LLM has been successfully trained if the answer matches the answer of the query-answer pair. In some embodiments, the machine-learning training module 230 may check to determine that the item name matches the item name in the catalog, that an item identifier in the answer matches the item identifier for the item in the catalog, or both.

In some embodiments, the evaluation may indicate that the enhanced LLM may need additional training for queries associated with an item. The machine-learning training module 230 may select a third subset of query-answer pairs that are associated with the item from the set of query-answer pairs. The third subset includes some queries of query-answer pairs that are not in the first subset. In some embodiments, the machine-learning training module 230 may generate additional queries for the third subset using the machine-learning model as described above. The machine-learning training module 230 may generate additional training examples that are associated with the item using the third subset. The machine-learning training module 230 may fine tune the enhanced LLM using the additional training examples. The machine-learning training module 230 may evaluate performance of the enhanced LLM using queries associated with the item that are from the second subset. This process may repeat until the machine-learning training module 230 has determined that the enhanced LLM is performing at the target level.

In some embodiments, the machine-learning training module 230 may retrain the enhanced LLM based on the actual performance of the enhanced LLM after the online system 140 has deployed the enhanced LLM to provide service to users. After sufficient additional training data has been acquired, the machine-learning training module 230 may re-train the enhanced LLM using the additional training data, using any of the methods described above. This deployment and re-training process may be repeated over the lifetime use for the enhanced LLM. This way, the enhanced LLM continues to improve its output and adapts to changes in the system environment, thereby improving the functionality of the online system 140 as a whole in its performance of the tasks described herein.

The data store 240 stores data used by the online system 140. For example, the data store 240 may store one or more catalogs, queries (e.g., generated by the machine-learning model) associated with items of the one or more catalogs, query-answer pairs, and training examples. The data store 240 also stores user data, item data (e.g., item name, item identifier, item description, etc.) for items of the one or more catalogs, order data, and picker data for use by the online system 140. The data store 240 also stores trained machine-learning models (e.g., the enhanced LLM, and in some cases the machine-learned model of the AI system 125) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

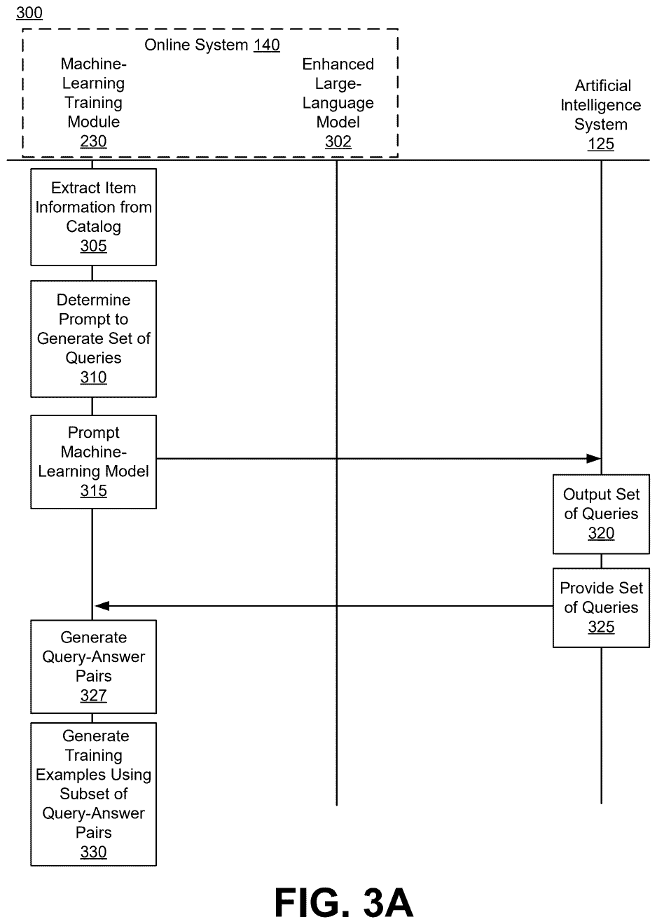

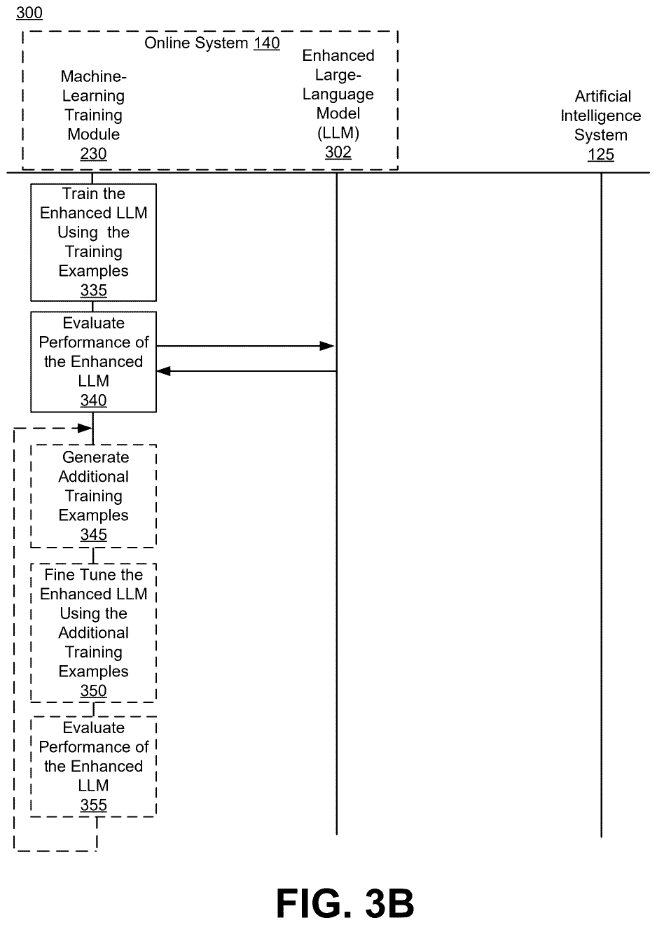

FIGS. 3A-3B form an example sequence diagram 300 that describes training an enhanced LLM 302, in accordance with some embodiments. Alternative embodiments may include more, fewer, or different interactions from those illustrated in FIGS. 3A-3B, and the steps may be performed in a different order from that illustrated in FIGS. 3A-3B. The enhanced LLM 302 is an example of the enhanced LLM described above with regard to FIGS. 1 and 2. The sequence diagram 300 describes some actions of the machine-learning training module 230 and an enhanced LLM 302 of the online system 140, and the AI system 125. Alternative embodiments may include more, fewer, or different components from those illustrated in FIGS. 3A-3B, and the functionality of each component may be divided between the components differently from the description below. For example, some or all of the functionality of the AI system 125 may be performed by the online system 140.

The machine-learning training module 230 extracts 305 item information (e.g., item names, item identifiers, and item descriptions) associated with items from the catalog. The machine-learning training module 230 extracts item information for some or all of the items of the catalog.

The machine-learning training module 230 determines 310 a prompt for a machine-learning model (e.g., of the AI system 125) to generate a set of queries based in part on the extracted item information. The prompts instruct the machine-learning model to generate the set of queries in a manner such that, for each item that item information was extracted, there is a corresponding plurality of queries whose answers are based on the item information for that item.

The machine-learning training module 230 prompts 315 a machine-learning model of the AI system 125 to generate a set of queries based in part on the item information associated with the items. The machine-learning model of the AI system 125 outputs 320 a set of queries responsive to the prompting. The AI system 125 provides 325 the set of queries to the online system 140.

The machine-learning training module 230 generates 327 a set of query-answer pairs using the received queries and the item information. A query-answer pair is associated with an item and includes a query and an answer to the query, wherein the answer is at least some of the item information (e.g., item name and item identifier) for the item. In other embodiments, the machine-learning model of the AI system 125 may be prompted such that it outputs query-answer pairs. The set of query-answer pairs can be organized into a plurality of groups that are associated with different items.

The machine-learning training module 230 generates 330 training examples using a first subset of the set of query-answer pairs. The machine-learning training module 230 selects, from the set of query-answer pairs, a plurality of query-answer pairs for each of the items from each of the plurality of groups to form the first subset of query-answer pairs. Each training example may be generated using a respective query-answer pair from the first subset. As such, a training example includes a query associated with an item and an answer to the query, where the answer is item information e.g., item name and item identifier) associated with the item.

The machine-learning training module 230 trains 335 an enhanced LLM using the training examples. For example, the machine-learning training module 230 may fine tune the enhanced LLM using the training examples.

The machine-learning training module 230 evaluates 340 performance of the enhanced large language model. The machine-learning training module 230 selects a second subset of the set of query-answer pairs that is separate from the first subset. The second subset includes queries that are different from the first subset. In some embodiments, the second subset includes queries from each of the plurality of groups. The machine-learning training module 230 prompts the enhanced LLM 302 with queries from the second subset to output a set of corresponding answers. The machine-learning training module 230 may compare answers output from the enhanced LLM 302 to answers of the query-answer pairs. In some embodiments, the machine-learning training module 230 may prompt, using correct item information that are answers to the second subset of queries, a machine-learning model (e.g., of the AI system 125) to identify queries whose answers, from the set of corresponding answers, do not include correct item information. The machine-learning training module 230 may determine how close an answer output from the enhanced LLM 302 in response to an applied query is to a correct answer (of the query-answer pair) for that query. The machine-learning training module 230 may, e.g., determine that the enhanced LLM 302 has been successfully trained if it returns correct answers (e.g., item name and item identifier) for applied queries.

In some embodiments, the evaluation may indicate that the enhanced LLM 302 may need additional training for one or more groups (that are associated with respective items). The machine-learning training module 230 may generate 345 additional training examples based on a third subset of the set of query-answer pairs. The machine-learning training module 230 may select a third subset of query-answer pairs from the set of query-answer pairs. The third subset includes queries from the one or more groups. The third subset includes some query-answer pairs that are not in the first subset, and in some embodiments are not part of the second subset. The machine-learning training module 230 may generate additional training examples that are associated with the one or more groups using the third subset.

The machine-learning training module 230 may re-train 350 the enhanced LLM 302 using the additional training examples. The retaining may include fine tuning the enhanced LLM 302 using the additional training examples. The machine-learning training module 230 may evaluate 355 performance of the enhanced LLM 302 for the one or more groups using queries from the one or more groups that are from the second subset. The evaluation is similar to that of step 340, but is for queries from the one or more groups. Steps 345-355 may repeat until the machine-learning training module 230 has determined that the enhanced LLM 302 is performing at a target level for queries from the one or more groups.

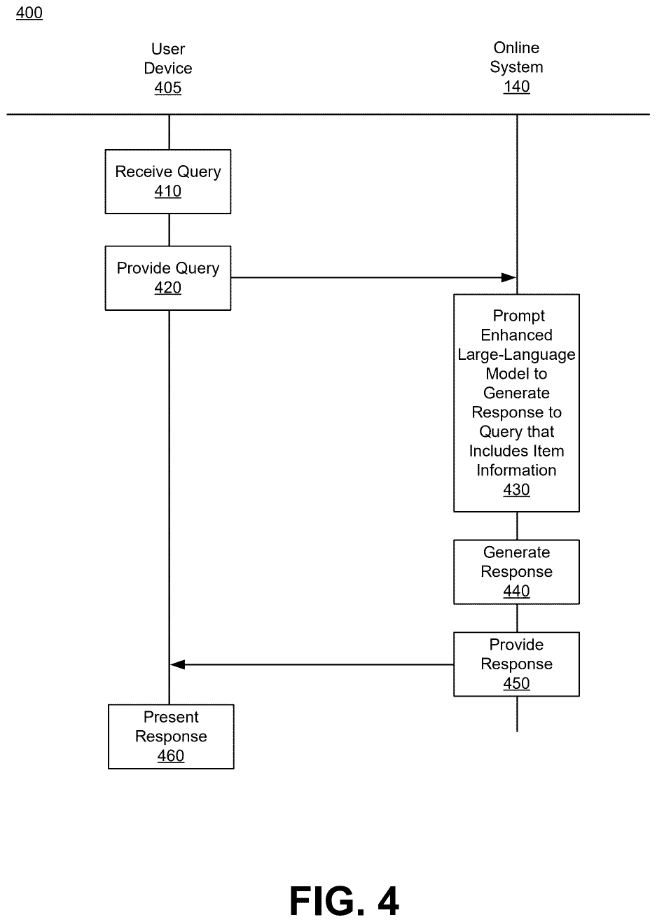

FIG. 4 is an example sequence diagram 400 that describes using an enhanced LLM to respond to queries with domain specific answers, in accordance with some embodiments. Alternative embodiments may include more, fewer, or different interactions from those illustrated in FIG. 4, and the steps may be performed in a different order from that illustrated in FIG. 4. The sequence diagram 400 describes some actions of a user device 405 and the online system 140. The user device 405 is an example of the user client device 100. Alternative embodiments may include more, fewer, or different components from those illustrated in FIG. 4, and the functionality of each component may be divided between the components differently from the description below.

The user device 405 receives 410 a query from a user of the user device 405. The query may request a recommendation for an item. The user device 405 may receive the query via an ordering interface. The user device 405 provides 420 the query to the online system 140.

The online system 140 may prompt 430 an enhanced LLM to generate an answer to the query. The enhanced LLM is an example of the enhanced LLM described above with regard to FIGS. 1-3B. The prompt may instruct the enhanced LLM to output an answer that includes item information for one or more items that satisfy the query. The item information may include item names and item identifiers for each of the one or more items, and in some embodiments, the item information also includes item descriptions for each of the one or more items.

The online system 140 generates 440 a response to the query that includes item recommendations that include item information for at least one of the one or more items. The item recommendations include the item name and item identifier for one or more of the one or more items. In some embodiments, the online system 140 may, e.g., use the item identifiers for the one or more items to retrieve additional item information (e.g., images, pricing information, etc.) about the one or more items. The online system 140 may generate for some or all of the one or more items item recommendations that includes the item name, the item identifier, and the retrieved additional item information. In some embodiments, the online system 140 may select one or more items that are likely to be of interest to the user from the one or more items, and generate item recommendations for the selected one or more items. The online system 140 provides 450 the response to the user device 405.

The user device 405 presents 460 the response to the user. In some embodiments, the user device 405 presents the response via the ordering interface of the user device 405.

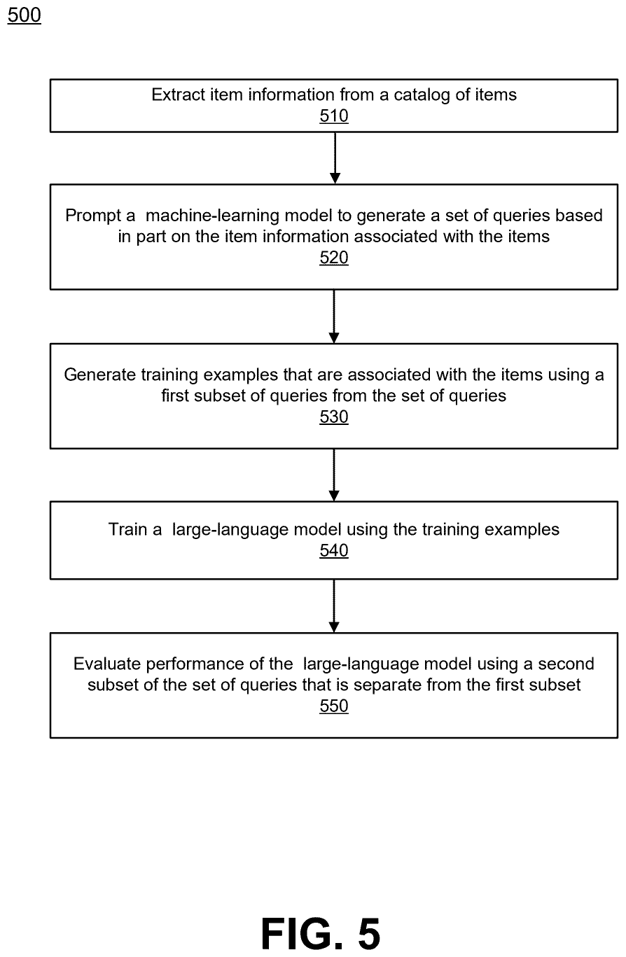

FIG. 5 is a flowchart for a method of training a large language model for domain specific answers, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system extracts 510 item information from a catalog of items. Each of the items has corresponding item information that includes an item name, an item identifier, and an item description.

The online system prompts 520 a machine-learning model to generate a set of queries based in part on the item information associated with the items. The set of queries may include, for each item, a plurality of queries and an answer that is common to the plurality of queries. As such, for a given item, there is a plurality of queries associated with the item, and an answer that is the same for the plurality of queries, where the answer is the item information for the item. In this manner, the plurality of queries for an item can be paired with the item information for the item to form a set of query-answer pairs. The set of query-answer pairs can be organized into a plurality of groups that are associated with different items.

The online system generates 530 training examples that are associated with the items using a first subset of queries from the set of queries. The first subset of queries are queries from a first subset of a set of query-answer pairs. Each training example is for a corresponding item. And each training example includes a query that is associated with the corresponding item and is from the first subset, and includes some item information that is an answer to the query and that is associated with the corresponding item. In this manner, a given training example includes a query and an answer to the query selected from one of the groups.

The online system trains 540 a LLM using the training examples. The LLM is an enhanced LLM as described above with regard to FIGS. 1-4. In some embodiments, the online system fine tunes the LLM using the training examples. The online system may use, e.g., PEFT and prefix tuning to fine tune the LLM. The online system may fine tune the LLM multiple times for each item.

The online system evaluates 550 performance of the LLM using a second subset of the set of queries that is separate from the first subset. The online system may select a second subset of the set of queries that is separate and different from the first subset. For example, the online system may select a second subset of the set of query-answer pairs, and queries from the second subset of query-answer pairs form the second subset of queries. The second subset of queries may include one or more queries from some or all of the groups that are not part of the first subset of queries. The online system may prompt the LLM with queries from the second subset of queries to output a set of corresponding answers. The online system compares answers output from the LLM to answers of the query-answer pairs (of the second subset). In this manner, the online system may determine how close an answer output from the LLM in response to an applied query is to a correct answer (of the query-answer pair) for that query. The machine-learning training module 230 may, e.g., determine that the enhanced LLM has been successfully trained if it returns correct answers (e.g., item name and item identifier) for applied queries. The online system may, e.g., determine that the LLM has been successfully trained if it returns correct item information for applied queries.

In embodiments, where the LLM is not returning the correct item information for a query associated with an item, the online system may, e.g., generate additional training examples using additional queries associated with the item. The online system may fine-tune the LLM using the additional training examples. The online system may evaluate performance of the LLM using queries associated with the item that are from the second subset to determine whether or not the LLM should be further trained. This process may repeat until the online system determines that the LLM has been successfully trained.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
extracting item information from an item catalog for each item of a plurality of items, wherein the item information for each item includes an item identifier for the item;
prompting a machine-learning model to generate, for each item of the plurality of items, a set of training query-answer pairs, wherein each training query-answer pair for an item includes a query about the item and an answer that comprises the item information for the item;
training a language model using the set of training query-answer pairs, wherein the language model is trained with each training query-answer using supervised learning in which the query serves as a prefix input to the language model and the answer serves as a target output for the language model;
receiving, from a first user device associated with a first user, a first query that requests a recommendation for an item;
prompting the trained language model to generate a response to the first query from the first user device, wherein the response includes the item identifier for a first item; and
generating, based on the response, a user interface that includes information about the first item, wherein generating the user interface causes the first user device to display the information about the first item to the first user.

2. The method of claim 1, wherein generating the user interface that includes information about the first item comprises:
obtaining, from the item catalog, an item name and an item description for the first item using the item identifier for the item; and
including the item name and the item description for the first item in the user interface.

3. The method of claim 1, wherein prompting the machine-learning model to generate the set of training query-answer pairs comprises prompting a large language model to generate the set of training query-answer pairs.

4. The method of claim 3, wherein prompting the large language model to generate the set of training query-answer pairs comprises receiving, from the large language model, for each training query-answer pair, a question about an item and an answer that comprises the item identifier for the item.

5. The method of claim 1, further comprising:
prompting a machine-learning model to generate, for each item of the plurality of items, a set of evaluation query-answer pairs, wherein each evaluation query-answer pair for an item includes a query about the item and an answer that comprises the item information for the item;
prompting the trained language model to generate a response to each query of the evaluation query-answer pairs; and
evaluating a performance of the language model based on the generated responses to the queries of the evaluation query-answer pairs.

6. The method of claim 5, wherein evaluating the performance of the language model comprises, for each evaluation query-answer pair, evaluating whether the response to the query from the language model matches the item information in the answer.

7. The method of claim 5, further comprising:
evaluating the performance of the language model to be below a threshold;
prompting the machine-learning model to generate a second set of training query-answer pairs, wherein each training query-answer pair for an item includes a query about the item and an answer that comprises the item information for the item; and
re-training the language model using the second set of training query-answer pairs.

8. A computer program product comprising a non-transitory computer readable storage medium having instructions encoded thereon that, when executed by a processor of a computer system, cause the computer system to perform steps comprising:
extracting item information from an item catalog for each item of a plurality of items, wherein the item information for each item includes an item identifier for the item;
prompting a machine-learning model to generate, for each item of the plurality of items, a set of training query-answer pairs, wherein each training query-answer pair for an item includes a query about the item and an answer that comprises the item information for the item;
training a language model using the set of training query-answer pairs, wherein the language model is trained with each training query-answer using supervised learning in which the query serves as a prefix input to the language model and the answer serves as a target output for the language model;
receiving, from a first user device associated with a first user, a first query that requests a recommendation for an item;
prompting the trained language model to generate a response to the first query from the first user device, wherein the response includes the item identifier for a first item; and
generating, based on the response, a user interface that includes information about the first item, wherein generating the user interface causes the first user device to display the information about the first item to the first user.

9. The computer program product of claim 8, wherein generating the user interface that includes information about the first item comprises:
obtaining, from the item catalog, an item name and an item description for the first item using the item identifier for the item; and
including the item name and the item description for the first item in the user interface.

10. The computer program product of claim 8, wherein prompting the machine-learning model to generate the set of training query-answer pairs comprises prompting a large language model to generate the set of training query-answer pairs.

11. The computer program product of claim 10, wherein prompting the large language model to generate the set of training query-answer pairs comprises receiving, from the large language model, for each training query-answer pair, a question about an item and an answer that comprises the item identifier for the item.

12. The computer program product of claim 8, wherein the non-transitory computer readable storage medium further has instructions encoded thereon that, when executed by a processor of a computer system, cause the computer system to perform steps comprising:
prompting a machine-learning model to generate, for each item of the plurality of items, a set of evaluation query-answer pairs, wherein each evaluation query-answer pair for an item includes a query about the item and an answer that comprises the item information for the item;
prompting the trained language model to generate a response to each query of the evaluation query-answer pairs; and
evaluating a performance of the language model based on the generated responses to the queries of the evaluation query-answer pairs.

13. The computer program product of claim 12, wherein evaluating the performance of the language model comprises, for each evaluation query-answer pair, evaluating whether the response to the query from the language model matches the item information in the answer.

14. The computer program product of claim 12, wherein the non-transitory computer readable storage medium further has instructions encoded thereon that, when executed by a processor of a computer system, cause the computer system to perform steps comprising:
evaluating the performance of the language model to be below a threshold;
prompting the machine-learning model to generate a second set of training query-answer pairs, wherein each training query-answer pair for an item includes a query about the item and an answer that comprises the item information for the item; and
re-training the language model using the second set of training query-answer pairs.

15. A computer system comprising:
a processor; and
a non-transitory computer readable storage medium having instructions encoded thereon that, when executed by the processor, cause the computer system to perform steps comprising:
extracting item information from an item catalog for each item of a plurality of items, wherein the item information for each item includes an item identifier for the item;
prompting a machine-learning model to generate, for each item of the plurality of items, a set of training query-answer pairs, wherein each training query-answer pair for an item includes a query about the item and an answer that comprises the item information for the item;
training a language model using the set of training query-answer pairs, wherein the language model is trained with each training query-answer using supervised learning in which the query serves as a prefix input to the language model and the answer serves as a target output for the language model;
receiving, from a first user device associated with a first user, a first query that requests a recommendation for an item;
prompting the trained language model to generate a response to the first query from the first user device, wherein the response includes the item identifier for a first item; and
generating, based on the response, a user interface that includes information about the first item, wherein generating the user interface causes the first user device to display the information about the first item to the first user.

16. The computer system of claim 15, wherein generating the user interface that includes information about the first item comprises:
obtaining, from the item catalog, an item name and an item description for the first item using the item identifier for the item; and
including the item name and the item description for the first item in the user interface.

17. The computer system of claim 15, wherein prompting the machine-learning model to generate the set of training query-answer pairs comprises prompting a large language model to generate the set of training query-answer pairs.

18. The computer system of claim 17, wherein prompting the large language model to generate the set of training query-answer pairs comprises receiving, from the large language model, for each training query-answer pair, a question about an item and an answer that comprises the item identifier for the item.

19. The computer system of claim 15, wherein the non-transitory computer readable storage medium further has instructions encoded thereon that, when executed by the processor, cause the computer system to perform steps comprising:
prompting a machine-learning model to generate, for each item of the plurality of items, a set of evaluation query-answer pairs, wherein each evaluation query-answer pair for an item includes a query about the item and an answer that comprises the item information for the item;
prompting the trained language model to generate a response to each query of the evaluation query-answer pairs; and
evaluating a performance of the language model based on the generated responses to the queries of the evaluation query-answer pairs.

20. The computer system of claim 19, wherein evaluating the performance of the language model comprises, for each evaluation query-answer pair, evaluating whether the response to the query from the language model matches the item information in the answer.
